(19) United States
(12) Patent Application Publication
(10) Pub. No.: US 2023/0338873 A1
(43) Pub. Date: Oct. 26, 2023

(54) CONTINUOUS LIQUID SEPARATING APPARATUS AND CONTINUOUS LIQUID SEPARATING METHOD

(71) Applicant: Hamari Chemicals, Ltd., Osaka (JP)

(72) Inventors: Shigeaki MASUDA, Osaka (JP); Masayuki OHIRA, Osaka (JP); Tetsuji KAWAMOTO, Osaka (JP); Yuji ISHIHARA, Osaka (JP)

(73) Assignee: Hamari Chemicals, Ltd., Osaka (JP)

(21) Appl. No.: 18/137,674

(22) Filed: Apr. 21, 2023

(30) Foreign Application Priority Data
Apr. 23, 2022 (JP) 2022-071203

(51) Int. Cl. B01D 17/02; B01D 17/12; G01F 23/292

(52) U.S. Cl. CPC B01D 17/0214; B01D 17/12; G01F 23/2921

(57) ABSTRACT

The continuous liquid separation is a continuous liquid separating apparatus that separates a first liquid and a second liquid that is immiscible to the first liquid and has a higher specific gravity than the first liquid, and includes: a liquid separating tank configured to contain a liquid, and be supplied with a liquid mixture of the first liquid and the second liquid, and including a first discharge portion on a lower side thereof and a second discharge portion disposed at a position higher than the first discharge portion, a valve configured to open/close the first discharge portion, a first sensor configured to detect a first water level of the liquid mixture contained in the liquid separating tank, the first water level being lower than the second discharge portion, and a second sensor configured to detect a second water level of the liquid mixture contained in the liquid separating tank.

### CROSS REFERENCE TO RELATED APPLICATION

This application claims priority to Japanese Patent Application No. 2022-071203 filed on Apr. 23, 2022, the entire contents of which are incorporated herein by reference.

### TECHNICAL FIELD

The present invention relates to a continuous liquid separating apparatus and a continuous liquid separating method.

### BACKGROUND ART

Various apparatuses that separate immiscible liquids have been proposed. Patent Document 1 proposes that, when discharging two or more immiscible liquids contained in a liquid separating tank, liquid separation is performed by measuring the velocity of ultrasonic waves of the liquids to be discharged, and automatically switching an open/close valve on the liquid interface while detecting a change in the velocity, for example.

JP H7-308511A is an example of related art.

### SUMMARY OF THE INVENTION

However, the above apparatuses perform liquid separation through batch processing, and thus the liquid separating tank needs to be supplied with a liquid at a predetermined interval. Therefore, it has not been possible to perform continuous liquid separation. The present invention has been made in order to resolve the foregoing issue, and an object thereof is to provide a continuous liquid separating apparatus and a continuous liquid separating method that enable continuous liquid separation with a simple configuration.

A continuous liquid separating apparatus according to the present invention is a continuous liquid separating apparatus that separates a first liquid and a second liquid that is immiscible to the first liquid and has a higher specific gravity than the first liquid, the apparatus including: a liquid separating tank configured to contain a liquid, and be supplied with a liquid mixture of the first liquid and the second liquid, and including a first discharge portion on a lower side thereof and a second discharge portion disposed at a position higher than the first discharge portion; a valve configured to open/close the first discharge portion; a first sensor configured to detect a first water level of a liquid mixture contained in the liquid separating tank, the first water level being lower than the second discharge portion; and a second sensor configured to detect a second water level of a liquid mixture contained in the liquid separating tank, the second water level being lower than the first water level and higher than the first discharge portion.

In the above continuous liquid separating apparatus, an overflow tube configured to discharge a liquid whose water level is higher than the second discharge portion can be coupled to the second discharge portion.

In the above continuous liquid separating apparatus, the first sensor and the second sensor can be photoelectric sensors, and at least a portion of the liquid separating tank that is irradiated with light from the first sensor and the second sensor can be formed by a translucent material.

In the above continuous liquid separating apparatus, a side tube that is adjacent to the liquid separating tank and extends in an up-down direction of the liquid separating tank can be further provided, the side tube can be in communication with the liquid separating tank, at least at two positions in the up-down direction below the second discharge portion, the first sensor and the second sensor can be photoelectric sensors, and are configured to detect a water level of a liquid mixture that fills the side tube, and at least a portion of the side tube that is irradiated with light from the first sensor and the second sensor can be formed by a translucent material.

A continuous liquid separating method according to the present invention is a continuous liquid separating method for separating a first liquid and a second liquid that is immiscible to the first liquid, and has a higher specific gravity than the first liquid, the method including: a step of closing a first discharge portion of a liquid separating tank configured to contain a liquid, and including the first discharge portion on a lower side thereof and a second discharge portion disposed at a position higher than the first discharge portion; a step of continuously supplying a liquid mixture of the first liquid and the second liquid to the liquid separating tank; a step of discharging, from the second discharge portion, the first liquid whose water level is higher than the second discharge portion, when the liquid mixture supplied to the liquid separating tank is contained in the liquid separating tank in a state of being separated into the first liquid and the second liquid; a step of opening the first discharge portion and discharging the second liquid from the first discharge portion, when a water level of the second liquid reaches a first water level that is lower than the second discharge portion; and a step of closing the first discharge portion when the water level of the second liquid reaches a second water level that is higher than the first discharge portion and lower than the first water level.

According to the present invention, it is possible to perform continuous liquid separation with a simple configuration.

### BRIEF DESCRIPTION OF THE DRAWINGS

FIG. 1 is a schematic diagram of a continuous liquid separating apparatus according to an embodiment of the present invention.

FIG. 2 is a diagram illustrating an operation of the continuous liquid separating apparatus in FIG. 1.

FIG. 3 is a diagram illustrating an operation of the continuous liquid separating apparatus in FIG. 1.

FIG. 4 is a diagram illustrating an operation of the continuous liquid separating apparatus in FIG. 1.

FIG. 5 is a diagram illustrating an operation of the continuous liquid separating apparatus in FIG. 1.

FIG. 6 is a schematic diagram showing another example of the continuous liquid separating apparatus according to the present invention.

### EMBODIMENTS OF THE INVENTION

An embodiment of a continuous liquid separating apparatus according to the present invention will be described below with reference to the drawings.

### 1. Structure of Continuous Liquid Separating Apparatus

The continuous liquid separating apparatus is an apparatus for separating a first liquid A and a second liquid B that are immiscible to each other. The second liquid B is a liquid that has a higher specific gravity than the first liquid A. These liquids are not particularly limited, but, for example, the following combinations of liquids can be separated from a liquid mixture, namely a combination thereof. Note that “aqueous solution” in Table 1 below may be an aqueous solution containing inorganic salts or inorganic acid such as sodium hydroxide, potassium hydroxide, sodium carbonate, potassium carbonate, phosphoric acid, hydrochloric acid, and sulfuric acid, or an aqueous solution containing organic salts or organic acid such as citric acid, succinic acid, maleic acid, triethylamine, and pyridine.

TABLE 1

| | A | B |
|---|---|---|
| 1 | Isopropyl acetate | Water or aqueous solution |
| 2 | Isopropyl acetate | Water or aqueous solution |
| 3 | Ethyl acetate | Water or aqueous solution |
| 4 | Toluene | Water or aqueous solution |
| 5 | Diethyl ether | Water or aqueous solution |
| 6 | Diisopropylether | Water or aqueous solution |
| 7 | Cyclopentyl methyl ether | Water or aqueous solution |
| 8 | Hexane | Water or aqueous solution |
| 9 | Heptane | Water |
| 10 | Water or aqueous solution | Dichloromethane |
| 11 | Water or aqueous solution | Chloroform |

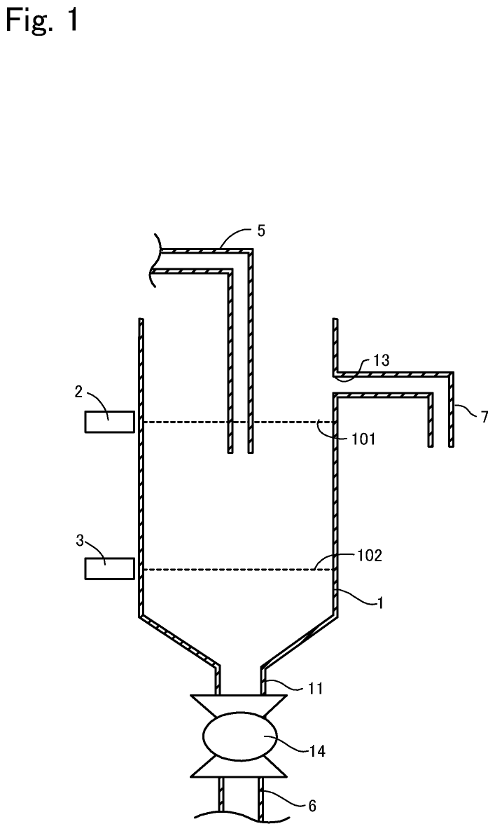

FIG. 1 is a schematic diagram showing one embodiment of the continuous liquid separating apparatus according to the present embodiment. As shown in FIG. 1, the continuous liquid separating apparatus includes a cylindrical liquid separating tank 1 whose upper portion is open, a first sensor 2, a second sensor 3, and a control unit 4 that controls the apparatus. The liquid separating tank 1 is continuously supplied with a liquid mixture of the first liquid A and the second liquid B from the upper opening via a supply tube 5 through which the liquid mixture flows. The supplied liquid mixture accumulates in the liquid separating tank 1 while being separated into the first liquid A and the second liquid B. That is to say, the second liquid B that has a higher specific gravity accumulates on the lower side of the liquid separating tank 1, and the first liquid A accumulates on top of the second liquid B.

A first discharge portion 11 is provided at a lower end portion of the liquid separating tank 1, and a discharge tube 6 is coupled to the first discharge portion 11. As will be described later, the separated second liquid B is discharged from this first discharge portion 11, and flows through the discharge tube 6. In addition, a valve 14 such as an electromagnetic valve is provided in the first discharge portion 11, and the control unit 4 opens/closes the valve 14.

On the other hand, a second discharge portion 13 is provided on a side surface of an upper end portion of the liquid separating tank 1, and an overflow tube 7 is coupled to the second discharge portion 13. As will be described later, the separated first liquid A is discharged from the second discharge portion 13, and flows through the overflow tube 7.

At an upper portion of the liquid separating tank 1, a first water level 101 is set below the second discharge portion 13, and, when the boundary between the first liquid A and the second liquid B contained in the liquid separating tank 1 reaches the first water level 101, the second liquid B is detected by the first sensor 2. Then, when the first sensor 2 detects the second liquid B, the control unit 4 opens the valve 14.

In addition, at a lower portion of the liquid separating tank 1, a second water level 102 is set at a position higher than the first discharge portion 11 and lower than the first water level 101, and, when the boundary between the first liquid A and the second liquid B contained in the liquid separating tank 1 reaches the second water level 102, the first liquid A is detected by the second sensor 3. Then, when the second sensor 3 detects the first liquid A, the control unit 4 closes the valve 14.

The first sensor 2 and the second sensor 3 are each constituted by a known photoelectric sensor that includes a light emitting portion and a light receiving portion. If, for example, the first liquid A is water or an aqueous solution, light emitted from the light emitting portion is absorbed by the water or aqueous solution, and thus cannot be received by the light receiving portion. On the other hand, if the second liquid B consists of an organic material, light emitted from the light emitting portion is received by the light receiving portion without being absorbed. Accordingly, it is possible to detect the first liquid A and the second liquid B while distinguishing between them.

In this case, in order to transmit light emitted from the sensors 2 and 3, a portion of the liquid separating tank 1 that is irradiated with light from the sensors 2 and 3 needs to be formed by a translucent material such as glass or a transparent resin. Alternatively, the entire liquid separating tank can also be formed by a material that can transmit light. In addition, the control unit 4 can be constituted by a known computer, a PLC, or the like.

### 2. Operations of Continuous Liquid Separating Apparatus

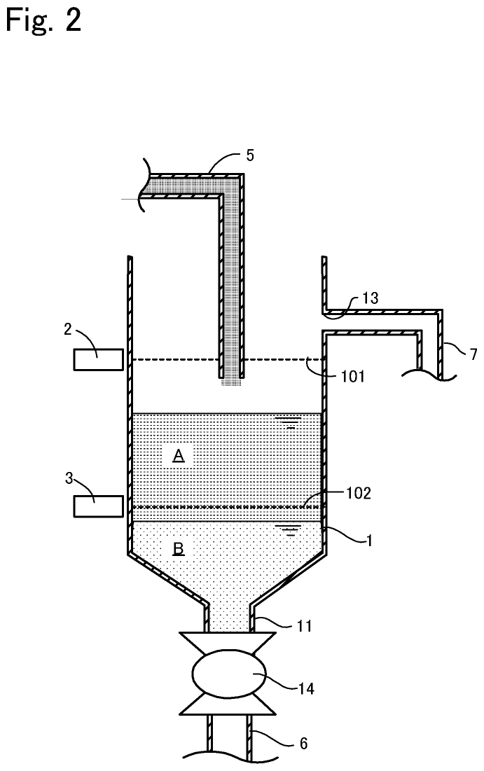

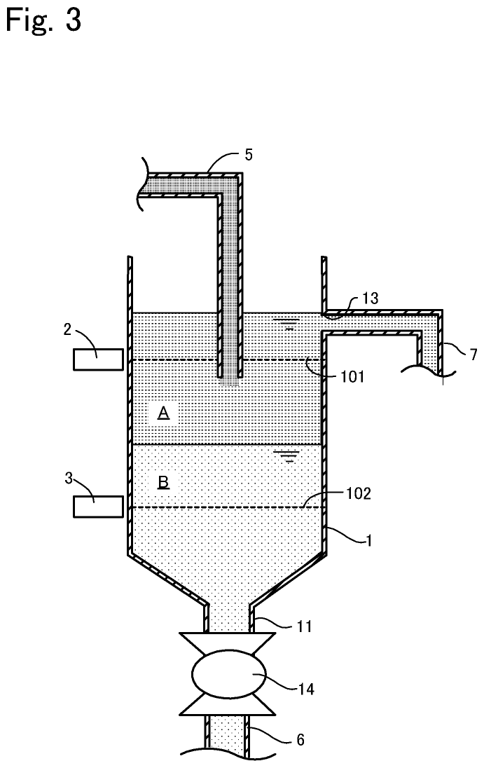

Next, operations of the continuous liquid separating apparatus configured as described above will be described with reference to FIGS. 2 to 4. First, the control unit 4 closes the valve 14 such that the liquid mixture accumulates in the liquid separating tank 1. Next, as shown in FIG. 2, a liquid mixture is supplied from the supply tube to the liquid separating tank 1. As described above, in the liquid separating tank 1, the supplied liquid mixture is separated into the first liquid A and the second liquid B, and the second liquid B accumulates on the lower side of the liquid separating tank 1, and the first liquid A accumulates on top of the second liquid B. Then, as shown in FIG. 3, when the water level of the first liquid A on the upper side rises above the lower limit of the second discharge portion 13, the first liquid A flows to the overflow tube 7 via the second discharge portion 13. Therefore, the first liquid A is separated from the liquid mixture.

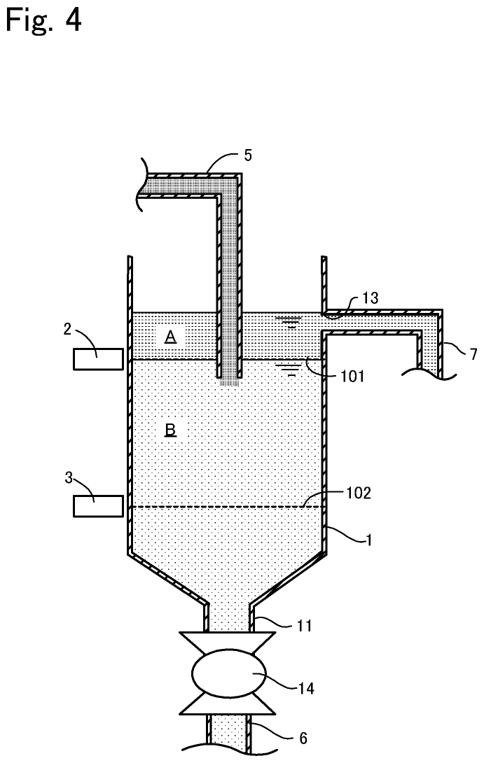

Also during this time, the liquid mixture is supplied to the liquid separating tank 1, but, as shown in FIG. 4, when the boundary between the first liquid A and the second liquid B reaches the first water level 101, and the second liquid B is detected by the first sensor 2, the control unit 4 opens the valve 14. Accordingly, the second liquid B that has accumulated on the lower side of the liquid separating tank 1 is discharged from the first discharge portion 11 to the discharge tube 6. Therefore, the second liquid B is separated from the liquid mixture. Note that, after the valve 14 is opened as described above, when the boundary between the first liquid A and the second liquid B reaches the first water level 101 while this boundary is falling, the valve remains open.

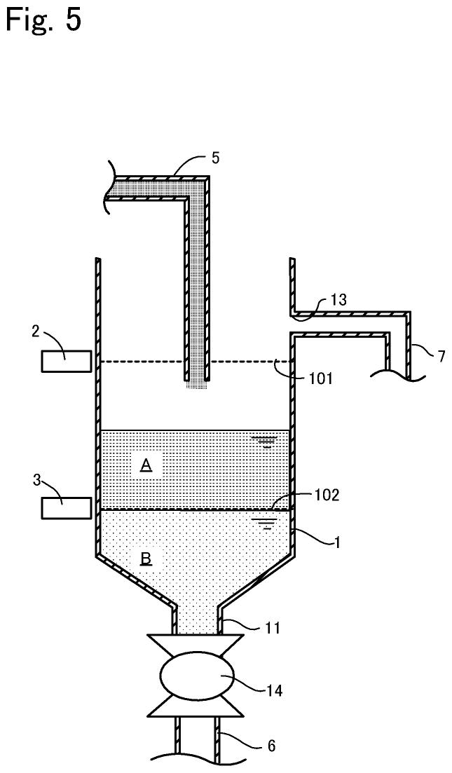

As the second liquid B is discharged, the water level of the boundary between the first liquid A and the second liquid B falls, and, as shown in FIG. 5, when the water level of this boundary reaches the second water level 102, and the first liquid A is detected by the second sensor 3, the control unit 4 closes the valve 14. Accordingly, discharge of the second liquid B is stopped. Subsequently, the valve 14 is repeatedly opened/closed while supply of the liquid mixture is continued, and the first liquid A and the second liquid B are separated from each other. Note that, after the valve 14 is closed as described above, when the boundary between the first liquid A and the second liquid B reaches the second water level 102 while this boundary is rising again, the valve remains closed.

### 3. Characteristics

As described above, according to the present embodiment, it is possible to perform continuous liquid separation with a simple configuration in which the two sensors 2 and 3 are mainly used. Therefore, maintenance is also easy. In addition, in the above continuous liquid separating apparatus, the first liquid A is discharged due to overflow, and the second liquid B is discharged by opening/closing the valve 14 while detecting the water level thereof, and thus there is no need to closely control the amount of liquid mixture that is supplied to the liquid separating tank 1, making it easy to control liquid separation.

The first sensor 2 and the second sensor 3 are each constituted by a photoelectric sensor, and thus the sensors 2 and 3 can be attached to the outside of the liquid separating tank 1. Therefore, for example, compared with sensors that are attached to the inside of the liquid separating tank 1 and come into contact with the liquid, there are advantages in that an extraneous material is prevented from entering the sensors 2 and 3, and that assembly and maintenance are easy.

The size of the liquid separating tank 1, the positions of the sensors 2 and 3 (the first water level 101 and the second water level 102), the supply amount of the liquid mixture, and the like can be changed as appropriate in accordance with the types of liquids that are to be separated, the processing speed, or the like, and, for example, the capacity of the liquid separating tank 1 can be 220 mL (an internal diameter of 4 cm and a height of 35 cm), the difference in height between the first water level 101 and the second water level 102 can be 15 cm, the difference in height between the first discharge portion 11 and the second water level 102 can be 12 cm, the difference in height between the second discharge portion 13 and the first water level 101 can be 13 cm, and the supply amount of the liquid mixture can be 36 L/min. It has been confirmed that, in this case, as an example, a liquid mixture of 23 L continuously supplied for 11 hours can be separated into water of 16 L (first liquid) and oil of 7 L (second liquid). In testing, the apparatus could be operated for 10 hours or longer in a continuous manner, and the valve was repeatedly opened/closed 300 times or more.

### 4. Modified Examples

One embodiment of the present invention has been described above, but the present invention is not limited thereto, and various changes can be made without departing from the spirit of the present invention. Note that the following modified examples can be combined as appropriate.

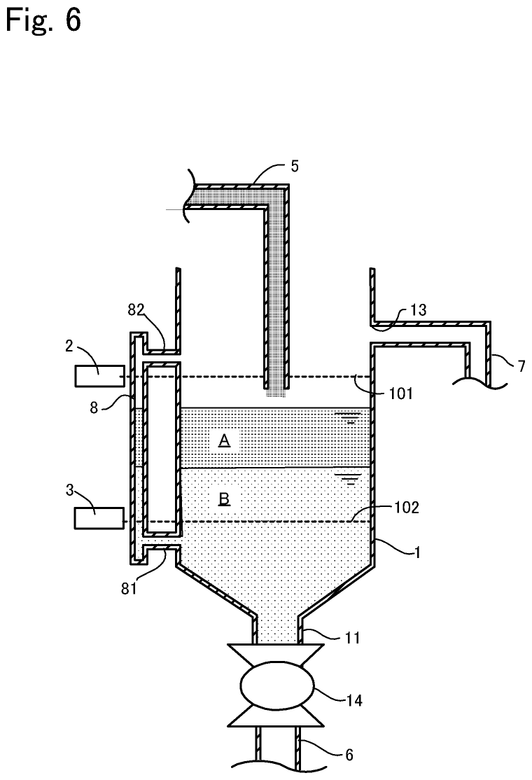

(1) In the above embodiment, the water level of a liquid mixture contained in the liquid separating tank is detected, but the following configuration can also be adopted. In the example shown in FIG. 6, a side tube 8 that is adjacent to the liquid separating tank 1 and extends in the up-down direction is provided. The side tube 8 is formed by a translucent material such as glass or a transparent resin, and has a smaller internal diameter than that of the liquid separating tank 1. The side tube 8 is in communication with the liquid separating tank 1 via coupling tubes 81 and 82 disposed at upper and lower positions. Therefore, the liquid mixture that is supplied to the liquid separating tank 1 also accumulates in the side tube 8 to the same water level as in the liquid separating tank 1. Note that the lower coupling tube 81 is coupled to the liquid separating tank 1, at a position higher than the first discharge portion 11, and the upper coupling tube 82 is coupled to the liquid separating tank 1, at a position lower than the second discharge portion 13.

Moreover, the first sensor 2 and the second sensor 3 are each constituted by a photoelectric sensor, and detect the water level of the boundary between the first liquid A and the second liquid B contained in the side tube 8. That is to say, the first sensor 2 is disposed below the upper coupling tube 82, and the second sensor 3 is disposed below the first sensor 2 and above the lower coupling tube 81.

The continuous liquid separating apparatus configured in this manner operates in a similar manner to that according to the above embodiment. Note that the only difference is that the first sensor 2 and the second sensor 3 detect the boundary between the first liquid A and the second liquid B that accumulate in the side tube 8.

With the above configuration, the water level in the liquid separating tank 1 is not directly detected by the sensors 2 and 3, and the water level of the liquid in the side tube 8 is detected by the sensors 2 and 3. For this reason, even if the sensors 2 and 3 are each constituted by a photoelectric sensor, there is no need to provide a light transmitting portion in the liquid separating tank 1, and water level can be detected in the side tube 8. The side tube 8 can be formed using a tube that has a small internal diameter, and thus the cost can be reduced compared with the case of providing a light transmitting portion in the liquid separating tank 1. Therefore, it is possible to reduce the apparatus cost when an inexpensive and accurate photoelectric sensor is used. When, for example, the capacity of the liquid separating tank 1 is 250 L (an internal diameter of 40 cm and a height of 200 cm), the capacity of the side tube 8 can be 22 L (an internal diameter of 20 cm and a height of 70 cm).

(2) The first sensor 2 and the second sensor 3 are not particularly limited, and any sensors that can detect the first liquid A or the second liquid B when the boundary between the first liquid A and the second liquid B reaches the first water level 101 and the second water level 102 may be used. An capacitive sensor that detects the capacitance of a liquid, and thereby detects the boundary between two liquids, an ultrasonic sensor that detects the interface between two liquids, and the like can be used, for example. Therefore, besides a sensor that is attached to the outside of the liquid separating tank 1, a sensor that is attached to the inside of the liquid separating tank 1, comes into direct contact with a liquid, and thereby detects the boundary may be used. In addition, a sensor that can detect the boundary between the first liquid A and the second liquid B based on the difference in the degree of light transmittivity or the difference in refractive index may also be used.

(3) It is also possible to provide a pump in the overflow tube 7, and suction the first liquid in the liquid separating tank 1. In addition, it is also possible to provide a valve in the second discharge portion 13, and control the discharge amount of the first liquid.

(4) The shape of the liquid separating tank 1 is not particularly limited, and can be various shapes such as a rectangular tube other than a circular tube. In the above embodiment, for example, the upper portion of the liquid separating tank 1 is open, but may be closed, and it suffices for the supply tube 5 for supplying a liquid mixture to be coupled to the upper portion of the liquid separating tank 1. In addition, in the above embodiment, the supply tube 5 is provided on the upper side of the liquid separating tank 1, and a liquid mixture is supplied from the upper side of the liquid separating tank 1, but, for example, a configuration may also be adopted in which the supply tube is coupled between the first water level 101 and the second water level 102 of the liquid separating tank 1, and a liquid mixture is supplied from this supply tube 5. In addition, the valve 14 provided in the liquid separating tank 1 is also not particularly limited, and the valve 14 may be any valve that can be opened or closed in conjunction with detection performed by the sensors 2 and 3.

### LIST OF REFERENCE NUMERALS

1 Liquid separating tank
11 First discharge portion
13 Second discharge portion
14 Valve
2 First sensor
3 Second sensor
7 Overflow tube
8 Side tube
101 First water level
102 Second water level
A First liquid
B Second liquid

What is claimed is:

1. A continuous liquid separating apparatus that separates a first liquid and a second liquid that is immiscible to the first liquid and has a higher specific gravity than the first liquid, the apparatus comprising:
a liquid separating tank configured to contain a liquid, and be supplied with a liquid mixture of the first liquid and the second liquid, and including a first discharge portion on a lower side thereof and a second discharge portion disposed at a position higher than the first discharge portion;
a valve configured to open/close the first discharge portion;
a first sensor configured to detect a first water level of the liquid mixture contained in the liquid separating tank, the first water level being lower than the second discharge portion; and
a second sensor configured to detect a second water level of the liquid mixture contained in the liquid separating tank, the second water level being lower than the first water level and higher than the first discharge portion.

2. The continuous liquid separating apparatus according to claim 1,
wherein an overflow tube configured to discharge a liquid whose water level is higher than the second discharge portion is coupled to the second discharge portion.

3. The continuous liquid separating apparatus according to claim 1,
wherein the first sensor and the second sensor are photoelectric sensors, and
at least a portion of the liquid separating tank that is irradiated with light from the first sensor and the second sensor is formed by a translucent material.

4. The continuous liquid separating apparatus according to claim 1, further comprising:
a side tube that is adjacent to the liquid separating tank and extends in an up-down direction of the liquid separating tank,
wherein the side tube is in communication with the liquid separating tank, at least at two positions in the up-down direction below the second discharge portion,
the first sensor and the second sensor are photoelectric sensors, and are configured to detect a water level of the liquid mixture that fills the side tube, and at least a portion of the side tube that is irradiated with light from the first sensor and the second sensor is formed by a translucent material.

5. A liquid separating method for separating a first liquid and a second liquid that is immiscible to the first liquid, and has a higher specific gravity than the first liquid, the method comprising:
closing a first discharge portion of a liquid separating tank configured to contain a liquid, and including the first discharge portion on a lower side thereof and a second discharge portion disposed at a position higher than the first discharge portion;
continuously supplying a liquid mixture of the first liquid and the second liquid to the liquid separating tank;
discharging, from the second discharge portion, the first liquid whose water level is higher than the second discharge portion, when the liquid mixture supplied to the liquid separating tank is contained in the liquid separating tank in a state of being separated into the first liquid and the second liquid;
opening the first discharge portion and discharging the second liquid from the first discharge portion, when a water level of the second liquid reaches a first water level that is lower than the second discharge portion; and
closing the first discharge portion when the water level of the second liquid reaches a second water level that is higher than the first discharge portion and lower than the first water level.
